(19) United States
(12) Patent Application Publication
(10) Pub. No.: US 2009/0324096 A1
(43) Pub. Date: Dec. 31, 2009

(54) METHOD AND APPARATUS FOR GROUPING SCANNED PAGES USING AN IMAGE PROCESSING APPARATUS

(75) Inventor: Shunichi Megawa, Shizouka-ken (JP)

Correspondence Address: FOLEY AND LARDNER LLP;SUITE 500, 3000 K STREET NW, WASHINGTON, DC, 20007, US

(73) Assignees: KABUSHIKI KAISHA TOSHIBA; TOSHIBA TEC KABUSHIKI KAISHA

(21) Appl. No.: 12/164,743

(22) Filed: Jun. 30, 2008

(51) Int. Cl. G06K 9/52

(52) U.S. Cl. 382/206

(57) ABSTRACT

An image forming apparatus and method for grouping pages with an image processing apparatus includes scanning each of a plurality of pages, detecting one or more features of each of the scanned pages, and grouping each of the plurality of scanned pages into at least first and second groups based on the detected features. Each of the at least first and second groups comprises at least one of the plurality of scanned pages.

### FIELD OF THE INVENTION

The present invention relates generally to the field of image processing, and more particularly to a method and apparatus for grouping scanned pages using an image processing apparatus.

### BACKGROUND OF THE INVENTION

A conventional image processing apparatus can receive pages of one or more documents and scan and/or copy the pages of the document. Upon scanning the pages of the document, the image processing apparatus can generate paper or electronic copies of the scanned pages. The paper or electronic copies can be grouped into one multi-page file comprised of all of the pages that the image processing apparatus scans. Alternatively, the paper or electronic copies can be grouped into multiple single-page files, each file comprised of a single scanned page.

Pages within a document often have like features that identify pages as belonging to a certain document. The ability to separate pages that can be scanned as a single set of pages but originate from multiple documents can lead to increased efficiency in the workplace. The human manpower required to sort scanned or copied pages after processing can be reduced. Accordingly, it would be useful to have a method and apparatus that can appropriately group scanned pages from one or more documents into their respective original document.

### SUMMARY OF THE INVENTION

According to an aspect of the invention, an image forming apparatus and method for grouping pages with an image processing apparatus includes scanning each of a plurality of pages, detecting one or more features of each of the scanned pages, and grouping each of the plurality of scanned pages into at least first and second groups based on the detected features. Each of the at least first and second groups comprises at least one of the plurality of scanned pages.

These and other features and advantages of embodiments will become apparent to those skilled in the art from the following detailed description and accompanying figures. It should be understood, however, that the detailed description and specific examples, including figures, while indicating various embodiments, are given by way of illustration and not limitation. Many modifications and changes within the scope of the embodiments may be made without departing from the spirit thereof and the invention includes all such modifications.

### BRIEF DESCRIPTION OF THE DRAWINGS

FIG. 1 is a flowchart illustrating a method for grouping scanned pages with an image processing apparatus according to an exemplary embodiment.

FIG. 2 is a flowchart illustrating a method for determining the group in which to place a scanned page according to an exemplary embodiment.

FIG. 3 is a block diagram of an image processing apparatus configured to group pages according to an exemplary embodiment.

### DETAILED DESCRIPTION OF THE PREFERRED EMBODIMENTS

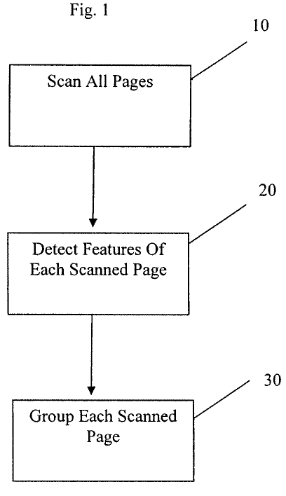

FIG. 1 is a flowchart illustrating a method for grouping scanned pages with an image processing apparatus according to an exemplary embodiment. As shown in FIG. 1, the image processing apparatus scans each of a plurality of pages (step 10). The pages that are scanned may be submitted to a scanning unit of the image processing apparatus by a feed tray or automatic document feeder (ADF). Rather than scanning the pages at the image forming apparatus, the scanned pages can be provided as image data over a network to which the image processing apparatus is connected. The scanning unit generates image data for each of the plurality of pages. The image data is preferably RGB data if the scanning unit of the image processing apparatus is capable of scanning color images. Otherwise, the image data may be monochromatic data. All of the plurality of pages are preferably scanned into the image processing apparatus before any of the plurality of pages are grouped, although the grouping of pages, as described in more detail below, may also be performed in parallel with the scanning of the pages.

The image data of the scanned pages can be buffered in a buffer, such as a page memory. The image data is preferably stored in the order in which each corresponding page was scanned. Upon the buffer completely filling, the information for the scanned page that has been buffered for the longest time may be output to and stored on the hard disk drive (HDD). The contents of the buffer may then be shifted to allow information for another scanned page to be input into the buffer. The oldest set of information can then again be output to the HDD. Alternately, the buffer may output information for more than one scanned page at a time.

Exemplary image processing apparatuses can include any image processing apparatus configured to scan a page and conduct image processing on the information retrieved from the scanned page. By way of example but not limitation, an exemplary image processing apparatus may be a scanner configured to scan documents. Alternately, an image processing apparatus may be an apparatus configured to scan documents and perform one or more other functions, such as the functions of a printer, a fax machine, a copier or a plotter. If the apparatus is configured to scan documents and perform printing and any other functions, the apparatus may be referred to as a multi-function printer (MFP).

In addition to scanning each of the plurality of pages, the image processing apparatus detects one or more features of each of the scanned pages (step 20). Exemplary features that may be detected for each page include, but are not limited to, whether the page is color or black and white (B/W), the number of columns of the page, whether the page has a portrait or landscape orientation, the page number of the page, as well as the location of the page number, the up or down orientation of the page, and the subpage number of the page. The features can be detected using image processing techniques. Exemplary image processing techniques for detecting the features are described in more detail below.

An exemplary method for determining whether each of the plurality of scanned pages is a color page or a black and white page is as follows. First, a color value for each pixel in the scanned page may be calculated according to the following equation:

|R−G|+|G−B|+|B−R|>colorvaluethreshold

Where R, G and B are red, green, and blue color density values, respectively, of a pixel and colorvaluethreshold is a threshold value set to determine if the pixel is color or not. In general, if there is a sufficient difference in color density among R, G, and B, then the pixel is color. Conversely, if there is little or no difference in color density among R, G, and B, then the pixel is black and white. The pixel is color if the product of the differences among R, G, and B exceed the colorvaluethreshold. The colorvaluethreshold can be a predetermined or default value set by the manufacturer. Alternatively, the colorvaluethreshold may be set by a user or technician. Assuming the color density values of R, G, and B are between 0 and 255, a preferred value for setting the colorvaluethreshold is 30, while other threshold values (e.g., an integer value between 10 and 50) may be utilized while remaining within the spirit and scope of the invention.

A count is kept of how many pixels are determined to be color in the scanned page. This count is compared to a colorpixelsthreshold, which is a threshold to determine if the scanned page is color or black and white. If the count of color pixels exceeds the colorpixelsthreshold, then the scanned page is color. Conversely, if the count of color pixels does not exceed the colorpixelsthreshold, then the scanned page is black and white. Like the colorvaluethreshold, the colorpixelsthreshold can be a predetermined or default value set by the manufacturer or be set by a user or technician.

In an exemplary method for determining whether the scanned page has a portrait or landscape orientation, Optical Character Recognition (OCR) can be performed to identify one or more characters on a scanned page. OCR is a method known to those of ordinary skill in the art to identify characters located in an image and translate the identified characters into computer-readable text. The characters may be, for example, alphanumeric or symbolic. OCR can be performed by any number of methods. By way of example, but not limitation, the shapes of characters can be determined by detecting patterns of light and dark in an image and using any of a plethora of character recognition methods, known to those of ordinary skill in the art, to identify the character. Character recognition methods may include, but are not limited to, an image processing technique known to those of ordinary skill in the art as pattern recognition.

Using the result of the OCR, a correlation is calculated between each of the identified characters on the scanned page and a character stored in the image processing apparatus. In addition, the scanned page can be assigned a score related to the correlation. Any number of techniques may be employed to determine a score. In pattern recognition of OCR, the characters of the recognition object are compared with a reference pattern. A resemblance degree of the character is then calculated as a result of this comparison. As a result of the calculation of the resemblance degree, a high score is assigned to the character having the highest resemblance degree, whereby the score corresponds to the resemblance degree.

The score of the scanned page and information indicating the particular rotation of the scanned page is stored. The rotation of the scanned page can be determined based on any number of methods known to those of ordinary skill in the art, including, but not limited to, comparison of the scanned page with the rotation of a reference scanned page.

The scanned page can be rotated by a predetermined number of degrees. The scanned page can be rotated clockwise or counterclockwise, and can be rotated, for example, by approximately 90, approximately 180 and/or approximately 270 degrees before each time that OCR is performed, and the corresponding correlation and score is calculated.

The steps of performing OCR, correlating, scoring, and rotating are repeated a predetermined number of times until all rotations of the page have been scanned and correlations and scores calculated. By way of example but not limitation, a page may be scanned a total of four times. The rotation of the scanned page with the highest score is determined, and the rotated scanned page corresponding to the highest score is selected. The width and the height of the selected scanned page are compared. If the width is less than height, then the scanned page can be identified as a portrait page. Conversely, if the width is greater than or equal to the height, then the scanned page can be identified as a landscape page.

An exemplary method for determining the number of columns of each of the plurality of scanned pages is as follows. First, one or more contiguous regions of text are identified. The contiguous regions of text can be identified using any number of image processing methods known to those of ordinary skill in the art. By way of example, but not limitation, a layout analysis technique may be used to identify regions of contiguous characters on the scanned page. For example, please refer to a layout analysis technique described, for example, in Japanese laid open patent application No. 2003-87562, which describes a layout analysis technique that may be utilized to identify regions of contiguous characters on a scanned page, which can be used with respect to at least one embodiment of the present invention. Valleys are identified as the areas of a scanned page between the identified regions. The number of valleys can be counted. If the number of valleys on a scanned page is zero, then the number of columns of the scanned page is identified as one. If the number of valleys on a scanned page is one, then the number of columns of the scanned page is identified as two. In general, the number of columns of a scanned page can be determined to be one more than the number of valleys on the scanned page.

An exemplary method for determining the page number of each of the plurality of scanned pages is as follows. First, OCR as described above can be used to identify one or more characters indicating the page number on a scanned page. OCR can be configured to evaluate characters positioned at a certain location known to coincide with the location of the page number on a scanned page. Alternatively, OCR can be configured to evaluate any characters on the page and use other methods well known to those of ordinary skill in the art to determine the characters corresponding to the page number.

An exemplary method for determining the up or down orientation of each of the plurality of scanned pages is as follows. First, characters on the scanned page may be identified using OCR as described above in the method of determining whether the scanned page is portrait or landscape orientation. In addition, like the process for determining whether a scanned page has a portrait or landscape orientation, a correlation between the identified characters and characters stored in the image processing can be calculated and a corresponding score can be stored. Further, after rotating the scanned page by 180 degrees, the correlation between identified characters and characters stored in the image processing apparatus and the corresponding score can be re-calculated and stored. If the score for the unrotated scanned page is higher than the rotated scanned page, then the scanned page is identified as having an up orientation. If the score for the unrotated scanned page is less than the rotated scanned page, then the scanned page is identified as having a down orientation.

An exemplary method for determining the subpage number of each of the plurality of scanned pages, which can be used with respect to at least one embodiment of the present invention, is described, for example, in Japanese laid open patent application No. 2002-215380, which describes a method for determining a subpage number of each of a plurality of scanned pages.

The detected features can be a constant or predetermined set used to process the set of scanned pages. Alternatively, the detected features can be changed or reset as desired to process the set of scanned pages. More particularly, the image processing apparatus can be programmed, either in advance or at the time that the pages are scanned into the apparatus, to detect a number and/or type of features. The number and type of features detected by the image processing apparatus can be programmed into the apparatus at the time of manufacture, at the time of purchase, prior to the processing of a set of scanned pages, or at some other convenient time.

Returning to FIG. 1, after detecting the features of each of the scanned pages, each of the plurality of scanned pages is grouped into at least first and second groups based on the detected features (step 30). Each of the at least first and second groups preferably comprises at least one of the plurality of scanned pages. The at least first and second groups can include pages having one or more specified detected features. The grouping can be performed in an order corresponding to the sequential order in which the pages were scanned.

A group of pages may be an electronic file of electronic versions of the scanned pages or a group of paper pages. The electronic files may be produced in any number of computer-readable formats. By way of example, but not limitation, the formats may be word processing formats such as .doc or .txt formats, or the formats may be image-based formats such as .pdf, .tiff, or .jpeg formats. After grouping scanned pages into groups, the groups can be reproduced for a user by any number of methods, including, but not limited to, collating or stapling all of the pages in each respective group.

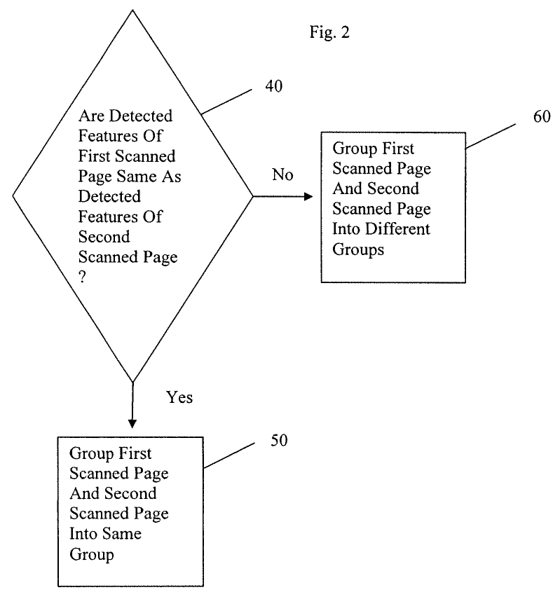

FIG. 2 is a flowchart illustrating a method for determining the group in which to place a scanned page according to an exemplary embodiment. As shown in FIG. 2, the detected features of a first scanned page are compared with the detected features of a second scanned page (step 40). If the detected features of the first scanned page and the detected features of the second scanned page are the same, then the first scanned page and the second scanned page are grouped into the same group (step 50). However, if the detected features of the first scanned page and the second scanned page are not the same, then the first scanned page and the second scanned page are be grouped into different groups (step 60). The first and second scanned pages have the same detected features if the number and type of features for the scanned pages are the same. For example, if the number of features is two, and the features types are color or black and white and up or down orientation, then the first and second scanned pages are grouped together if they are both color (or both black and white) and both have an up (or down) orientation. The process of FIG. 2 is repeated for each successive pair of pages, e.g., the second and third scanned pages, the third and fourth scanned pages, etc.

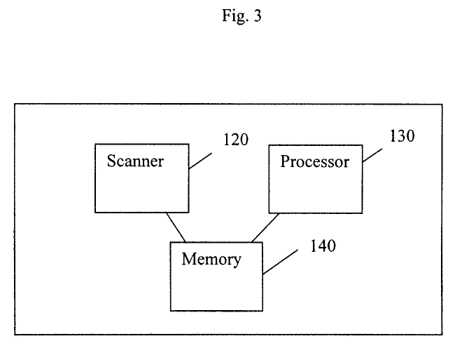

FIG. 3 is a block diagram of an image processing apparatus configured to group pages according to an exemplary embodiment. As shown in FIG. 3, the image processing apparatus comprises a scanner 120, a processor 130 and a memory 140. The scanner may be any device configured to scan pages in paper or electronic form and generate electronic information describing the scanned page. The scanner may scan all of the plurality of pages before any of the plurality of pages are grouped.

The processor 130 can be configured to control the operation of the image processing apparatus. The memory 140 is coupled to the processor 130 and preferably comprises instructions to enable the image processing apparatus to detect features of each of the scanned pages and to group each of the plurality of scanned pages into at least first and second groups based on the detected features. Each of the at least first and second groups preferably comprises at least one of the plurality of scanned pages. The memory 140 can be implemented, for example, as a ROM, a RAM or some combination thereof. The detected features may be one or more of the detected features described above with reference to FIG. 1.

The foregoing description of embodiments of the present invention have been presented for purposes of illustration and description. It is not intended to be exhaustive or to limit the present invention to the precise form disclosed, and modifications and variations are possible in light of the above teachings or may be acquired from practice of the present invention. The embodiments were chosen and described in order to explain the principles of the present invention and its practical application to enable one skilled in the art to utilize the present invention in various embodiments and with various modifications as are suited to the particular use contemplated.

What is claimed is:

1. A method for grouping pages with an image processing apparatus, comprising:
scanning each of a plurality of pages;
detecting one or more features of each of the scanned pages; and
grouping each of the plurality of scanned pages into at least first and second groups based on the detected features, each of the at least first and second groups comprising at least one of the plurality of scanned pages.

2. The method of claim 1, wherein all of the plurality of pages are scanned before any of the plurality of scanned pages are grouped.

3. The method of claim 1, wherein grouping is performed in an order corresponding to the sequential order of the scanned pages.

4. The method of claim 1, wherein grouping each of the plurality of scanned pages into a respective plurality of groups based on detected features comprises:
comparing the detected features of a first scanned page with the detected features of a second scanned page;
grouping the first scanned page and the second scanned page together if the detected features of the first scanned page and the detected features of the second scanned page are the same; and
grouping the first scanned page and the second scanned page into different groups if the detected features of the first scanned page and the detected features of the second scanned page are not the same.

5. The method of claim 1, wherein the detected features of each of the plurality of scanned pages comprises whether each of the plurality of scanned pages is a color page or a black and white page.

6. The method of claim 1, wherein the detected features of each of the plurality of scanned pages comprises the number of columns of each of the plurality of scanned page.

7. The method of claim 1, wherein the detected features of each of the plurality of scanned pages comprises whether each of the plurality of scanned pages has a portrait or landscape orientation.

8. The method of claim 1, wherein the detected features of each of the plurality of scanned pages comprises a page number of each of the plurality of scanned pages.

9. The method of claim 1, wherein the detected features of each of the plurality of scanned pages comprises the up or down orientation of each of the plurality of scanned pages.

10. The method of claim 1, wherein the detected features of each of the plurality of scanned pages comprises at least two detected features among color or black and white, number of columns, portrait or landscape orientation, page number, and up or down orientation.

11. An image processing apparatus configured to group pages, comprising:
a scanner configured to scan a plurality of pages;
a processor; and
a memory coupled to said processor, said memory comprising a plurality of instructions executed by said processor, said plurality of instructions configured to:
detect features of each of the scanned pages; and
group each of the plurality of scanned pages into at least first and second groups based on the detected features, each of the at least first and second groups comprising at least one of the plurality of scanned pages.

12. The image processing apparatus of claim 11, wherein the scanner scans all of the plurality of pages before any of the plurality of pages are grouped.

13. The image processing apparatus of claim 11, wherein the memory further comprises an instruction configured to group each of the plurality of scanned pages into at least first and second groups in an order corresponding to the sequential order of the scanned pages.

14. The image processing apparatus of claim 11, wherein the memory further comprises instructions configured to:
compare the detected features of a first scanned page with the detected features of a second scanned page;
group the first scanned page and the second scanned page together if the detected features of the first scanned page and the detected features of the second scanned page document are the same; and
group the first scanned page and the second scanned page into different groups if the detected features of the first scanned page and the detected features of the second scanned page are not the same.

15. The image processing apparatus of claim 11, wherein the detected features of each of the plurality of scanned pages comprises whether the scanned page is a color page or a black and white page.

16. The image processing apparatus of claim 11, wherein the detected features of each of the plurality of scanned pages comprises the number of columns of the scanned page.

17. The image processing apparatus of claim 11, wherein the detected features of each of the plurality of scanned pages comprises whether the scanned page has portrait or landscape orientation.

18. The image processing apparatus of claim 11, wherein the detected features of each of the plurality of scanned pages comprises the page number of each of the plurality of scanned pages.

19. The image processing apparatus of claim 11, wherein the detected features of each of the plurality of scanned pages comprises the up or down orientation of each of the plurality of scanned pages.

20. The image processing apparatus of claim 11, wherein the detected features of each of the plurality of scanned pages comprises at least two detected features among color or black and white, number of columns, portrait or landscape orientation, page number, and up or down orientation.
